(19) United States
(12) Patent Application Publication
(10) Pub. No.: US 2005/0039043 A1
(43) Pub. Date: Feb. 17, 2005

(54) Method of securing requests for access to services, terminal and software module for implementing the method

(75) Inventors: Benoit De Boursetty, New York, NY (US); Laurent Frisch, Paris (FR); Franck Veysset, Issy Les Moulineaux (FR)

Correspondence Address: GARDNER CARTON & DOUGLAS LLP;ATTN: PATENT DOCKET DEPT., 191 N. WACKER DRIVE, SUITE 3700, CHICAGO, IL, 60606, US

(73) Assignee: FRANCE TELECOM, Paris (FR)

(21) Appl. No.: 10/900,886

(22) Filed: Jul. 28, 2004

(30) Foreign Application Priority Data
Jul. 29, 2003 (FR) 0309308

(51) Int. Cl. H04L 9/00

(52) U.S. Cl. 713/200

(57) ABSTRACT

A method of securing requests for access to services from a terminal (1) able to communicate with a plurality of service operators (A; B) delivering respective services, comprising the following steps:
furnishing the terminal with at least one software component (6; 7) provided by an operator delivering at least one service with a particular access condition, upon a request for access to the said service from the terminal by way of a communications network, executing the software component provided by the operator locally in the terminal, the execution of the software component comprising at least the presentation to a user of the terminal of an indication defined by the operator in the component in relation to the particular access condition of the service.

The present invention relates to the field of remote access to services by way of a communication network.

Certain services may exhibit particular access conditions: the latter are for example a pay service with a given tariff, the presence of third parties called on to receive registered information about the user of the service, etc. Certain services may also comprise operations whose effect is to erase data belonging to the user. The service access condition may also combine several of these aspects.

The ordering of such services, or more generally access to these services, must form the subject of operations aimed at confirming that it is actually desired by the user, in full knowledge of the facts. The operations may take the form of an information item, sometimes legally compulsory (for example in the case of private information provided to third parties) or else of a request for agreement from the user. For example, when the service is a pay service, it is necessary for the user to agree to consume this service. Otherwise, he may be surprised by the operator's bill and contest it.

Now, the appearance of user terminals open to the downloading of local computer applications introduces problems in this field, increasing the risks of the bill for the services consumed by the user being contested.

Specifically, when the IT systems of a service operator receive from one of their customers the order to access a service (for example, the order to place a telephone call, the order to send a digital message or the order to execute a payment), the operator's billing subsystem books this event to the customer in question, this possibly giving rise to billing.

However, the service operator is bound by the terminal used to communicate with his customer. For example, in the case of telephony services, if a terminal equipped with underhand IT applications places an order for telephone calls unbeknown to the user, the latter will a priori contest the bill presented by his telephone operator. Should there be litigation with regard to the bill, the determination of responsibility of the user or of the operator is not straightforward and is potentially expensive to establish. Moreover, even if the final responsibility were thrown back on the user, serving the latter with a writ for payment of his bill as is, users' trust in their operator would be greatly damaged. For the service operator, this constitutes a risk of loss of value of his customer relations.

It will be noted that the problem posed by underhand applications should not be confused with so-called authentication problem, which appears especially within the framework of wireless networks such as GSM or UMTS. The problem of authentication consists in ensuring that an attacker cannot usurp the identity of a customer. In the case of GSM networks it is resolved with the aid of a symmetric authentication (without preventing attacks by interposition) and more completely in UMTS networks. Security is strengthened through the use of a chip card making it more difficult to duplicate the secret keys employed by the user for authentication. However, even when authentication is carried out in a secure manner, the problem of underhand applications exists. Furthermore, it exists always within the framework of services offered on an IT terminal via a fixed telecommunications network, in which the problem of authentication arises to a lesser extent.

Certain techniques exist for securing remote orders for services exhibiting particular access conditions, the operator advising his customers of the price of the services consumed on the terminal used to access same. For example, in the case of GSM mobile telephony, an optional service of the network (the Advice of Charge service [3GPP 24.086, v. 5.0.0]) allows the user to be informed of the price of the calls that he makes.

In the case of Minitel, pressing the “Summary” button during connection setup signifies to the server a request to display the price, which is transmitted continuously during consultation of the service.

These systems have the drawback however of necessitating the setting up of a communication channel for displaying the price, which channel represents a cost for the operator.

Moreover, certain service operators choose to solve the problem of underhand applications by very carefully selecting the terminals that can be used to perform transactions, and by making it difficult to install additional IT applications. Thus, for example, automatic bank tellers or electronic payment terminals are subjected to rigorous monitoring on the part of the banks or banking networks that use them to offer their services remotely: in the specifications of these terminals, the installation of new IT applications is strictly monitored.

It is thus possible to limit the downloading to applications whose behaviour will have formed the subject of a prior audit. This is possible, for example, by using terminals that execute applications only if the latter are digitally signed, with a public key certificate authorized by the service operator. This may be the case for terminals operating with Microsoft Smartphone 2002 operating system, with the functionality of executing unsigned applications being deactivated.

Another way for the operator to limit the risks is to permit the downloading, again by means of a digital signing system, when the publisher of each application agrees to take responsibility for damages occasioned by a possible malfunction of his application. There is no technical difference, on the terminal, between this method and that described in the previous paragraph.

These methods combine a technical approach (digital signing) with guarantees afforded in a manner external to the system (guarantee of good behaviour of the application, external taking of responsibility).

However, the approach combining digital signing of the applications and external monitoring has as main drawback the cost of the external monitoring procedures. The application certification procedures or those for taking responsibility in the case of poor behaviour of a terminal, are complex and expensive to put in place since they require the setting up of a privileged relationship between the service operator and the applications publisher.

Within the field of mobile telephony, terminals that have appeared recently offer their owners the possibility of downloading IT applications of any origin. These are for example terminals allowing the downloading of MIDP 2.0 (Sun Microsystems) Java technology applications, or of applications for the Microsoft Smartphone 2002 (Microsoft), Symbian OS 7.0 (Symbian), PalmOS (PalmSource) operating systems, etc. Applications on such terminals have, depending on the case, the capacity to access various services offered by the mobile telephony operator on the terminal, such as for example the traditional telephony service, digital telecommunication services, multimedia messaging services, etc. If such applications, downloaded by the user, were to use the operator's pay services without warning the user thereof, there would be the possibility of the bill being contested.

In order to avoid discontent such as this, certain technologies make it possible, whatever the application downloaded, to ensure the agreement of the customer before confirming access to services via an application. For example, when an application wishes to send a digital message over a GSM network by means of short messages (Short Message Service or SMS), a form asking on the screen of the terminal for the user's agreement before sending the message may be demanded by the terminal before the application request is executed.

Depending on the terminals and services considered, the customer's agreement may be requested on each occasion. Agreement may also be given by the user to an application for a given period of time, or else permanently, so as not to tire the user with repetitive questions. By way of example, mention may be made of the MIDP 2.0 specification and in particular its annex “The Recommended Security Policy for GSM/UMTS Compliant Devices”.

This type of method, which consists in restricting the capabilities of the applications, does not require any digital signing and external monitoring. Nevertheless, the two approaches (restriction on the one hand, signing and external monitoring on the other hand) may possibly be combined.

However, one of the problems of the approach consisting in tolerating the applications while restricting their capabilities stems from the variety of tariff rates relating to the same services offered by competing operators. Thus, for example, one and the same service making repeated use of a service for obtaining the weather could be pay as you go for an operator A, and subject to a monthly flat-rate contract comprising an unlimited number of requests for another operator B. How does one specify a terminal making it possible to access either of these two competing operators? Operator A, for which payment is made as you go, will probably want to be sure of the user's agreement before the order for the service is placed, at each order, by the terminal; a restriction of the capability of the applications to access this service will therefore be welcome. On the other hand, operator B will probably want access to this service not to be restricted; specifically, there would be no reason for such a restriction on account of the unlimited use enjoyed by the user.

The existing techniques do not make it possible to specify a terminal taking into account the validity of the choices of the operators in the matter concerned, thereby resulting in a security policy which is, for many operators, either too lax, or too strict. Ideally, each service operator ought to be able to inform the user or to be sure of his agreement before accomplishing actions that will have a cost for the user, and make sure thereof in the manner that he wishes. Thus, this would avoid having overly lax policies in which the user may be legitimately deceived by his bill or, conversely, overly strict ones in which the user must give his explicit agreement for services that have no impact on his final bill.

The present invention aims to propose a method of securing requests for access to services exhibiting a particular condition of access from a terminal, which is less affected by the limitations of the earlier solutions mentioned above.

Thus, according to a first aspect, the invention proposes a method of securing requests for access to services from a terminal able to communicate with a plurality of service operators delivering respective services, comprising the following steps:
furnishing the terminal with at least one software component provided by an operator delivering at least one service with a particular access condition,
upon a request for access to the said service from the terminal by way of a communications network, executing the software component provided by the operator locally in the terminal, the execution of the software component comprising at least the presentation to a user of the terminal of an indication defined by the operator in the component in relation to the particular access condition of the service.

Such a method thus makes it possible to guarantee that the request for a service and the associated particular access condition are well known to the user, without consuming network resources on each occasion and while allowing a type of security adapted to each operator's choice.

The indication presented may, as a function of the operator's choice, take the form for example of an information item displayed for the user, relating to the particular access condition, or else of a request for agreement in respect of a request for the service exhibiting the particular agreement condition. Access to the service may be provided depending on the case, before the indication, simultaneously or afterwards.

A method according to the invention furthermore makes it possible to decorrelate the aspects relating to the specifications of an application present in the terminal, from the aspects relating to the specifications for security requested by an operator that provides a service upon which the application calls.

Specifically the programming of these various aspects may be done separately. The updates of the information that the operator wishes to show the user, or a change of operators that is made apparent by the changing of the security specifications, may be carried out by changing the component without having to reload the application itself into the terminal. And conversely, modifications of the application may be implemented without going back on the aspects relating to the security choices of the operators upon which the application calls. This flexibility is made apparent through a rationalization of the implementation tasks and a lowering of the costs relating thereto.

According to a second aspect, the invention proposes a terminal for securing requests for access to services, which is able to communicate with a plurality of service operators delivering respective services, comprising means including at least one security software component adapted to the implementation of the steps of a security method according to the first aspect of the invention.

According to a third aspect, the invention proposes a software module for securing requests for access to services, to be executed in a terminal able to communicate with a plurality of service operators delivering respective services, comprising instructions for implementing the steps of a method of securing requests for access to services according to the first aspect of the invention.

In one mode of deployment of the invention, a terminal will thus be able, when ordering a service provided by two competing operators A, B by way of the same network, to chose one of the two operators. In the case where the terminal has been equipped with a component, according to the invention, relating to the operator chosen and to the service adopted exhibiting a particular access condition, the component will execute so as to warn the user of the terminal of this access condition.

In another embodiment of the invention, a terminal operating within a network will be able to communicate with only one service operator at a time, doing so for example as a function of the network chosen by the user. For example, a terminal is firstly used by a user in a network R1 for a unique telephony service rendered by an operator A, wishing systematically to inform the users of the telephone tariffs in force. Upon the first connection to the network, the operator A downloads the component according to the invention to the terminal. Subsequently, the user will be able to decide to change telephone operator and will choose the operator B providing a telephony service for example via a network R2. The operator B will then be able likewise to furnish the terminal with the component he has chosen, for example upon the first connection of the terminal to the network R2.

Other characteristics and advantages of the invention will become further apparent on reading the description which follows. The latter is purely illustrative and should be read in conjunction with the appended drawings in which:

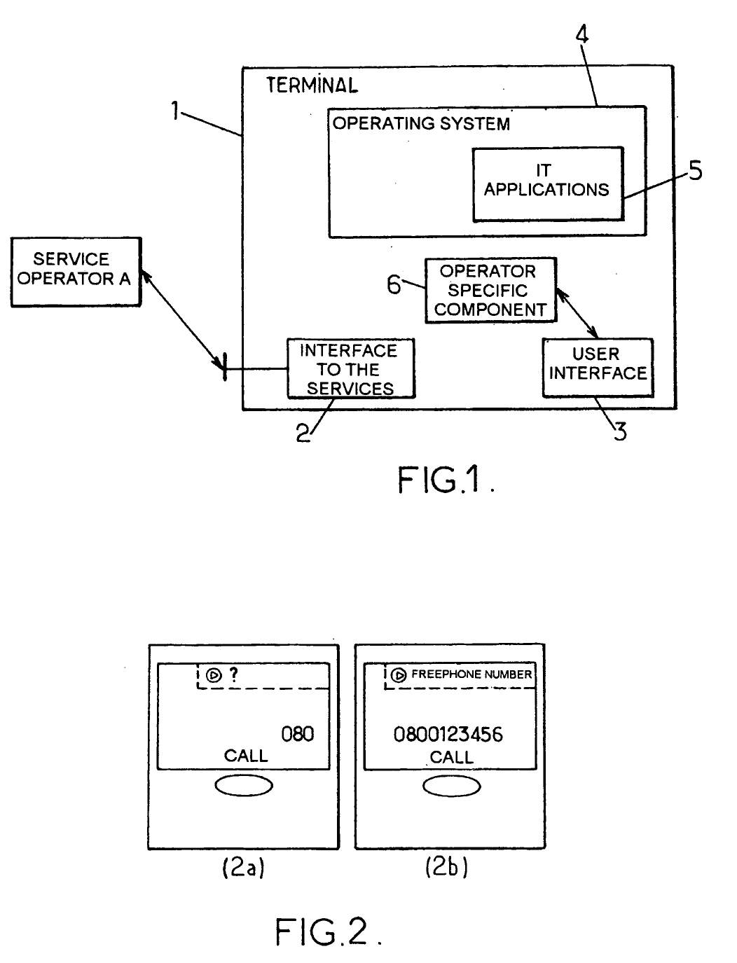

FIG. 1 represents a terminal in a first embodiment of the invention;

FIG. 2 represents two states of a screen of a terminal in the embodiment of FIG. 1;

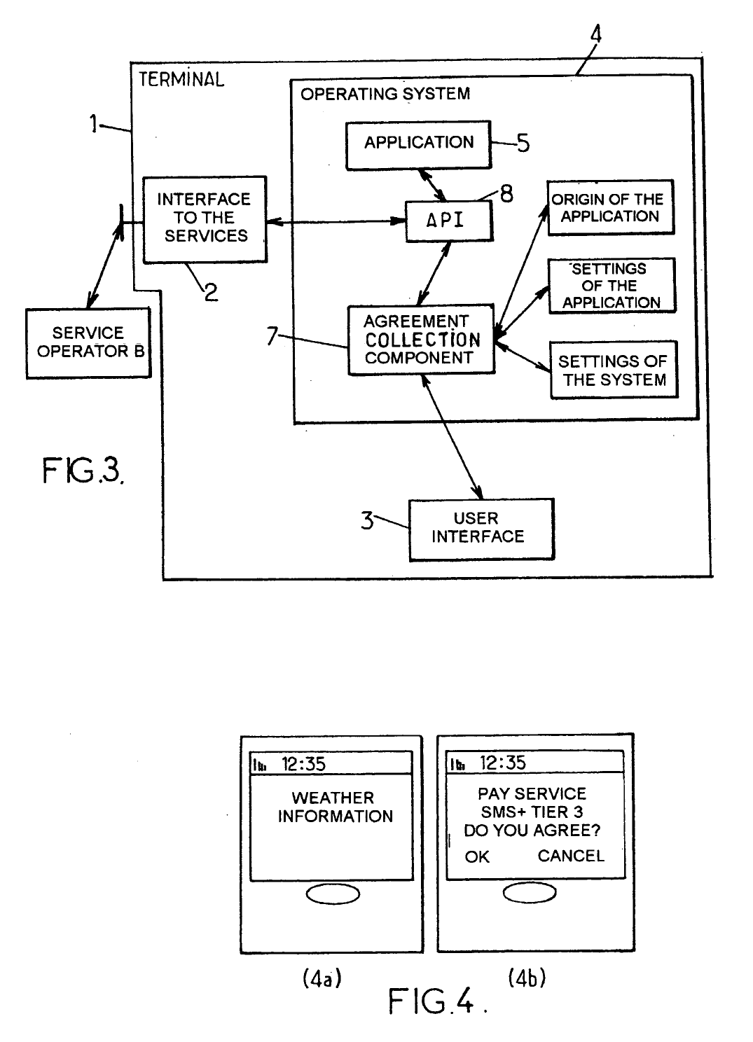

FIG. 3 represents a terminal in a second embodiment of the invention.

FIG. 4 represents two states of a screen of a terminal in a third embodiment of the invention.

Represented in FIG. 1 is a terminal 1 in a first embodiment of the invention, making it possible to order services provided by service operators.

The terminal 1 comprises a user interface 3 allowing it to communicate with its user, and which monitors the peripherals used by the user (keyboard, screen).

The terminal 1 furthermore comprises an operating system 4, as well as IT applications 5, downloaded or otherwise. Access to the services by these applications and to the user interface 3 is made possible by means of the operating system 4.

The terminal 1 furthermore comprises a specific component 6 in respect of an operator A. The user interface 3 possesses an interface intended to be integrated with the component 6.

The service operator A has previously provided the executable code of the component 6, which relates to the services offered thereby and which are accessible from the terminal 1.

It has for example been delivered by the operator A to the terminal by a mechanism for making available the component destined for the terminal (pull type methods), or via a mechanism for sending this component to the terminal (push type methods).

This component, adapted to the terminal of the customer user (written for example in Java type mobile code, in an executable code dedicated to the operating system of the terminal or else in a specialized language) is thereafter integrated into this terminal while interfacing with the user interface 3 by means of the interface provided for this purpose. It is through this means that the indication component will interact with the user, allowing bidirectional communication.

The bidirectional communication in this first embodiment is as follows:
the user communicates to the terminal 1, by way of the user interface 3, information relating to a service that he wants to use. For example, in the case of a service of telephony type by the operator A, he keys in the number requested;
the terminal then sends the user an item of information relating to the service requested, for example the tariff corresponding to the number called. The component 6 has among its functions set up previously by the operator A, that of providing this item of information when the service chosen by the user and provided by the operator A is ordered.

Such a component 6 will be called the indication component, since it simply provides an indication regarding the particular conditions of the service chosen by the user and provided by the operator A.

Considered hereinbelow is a telephony service provided by the operator A, and a terminal 1 whose indication component 6 is written by means of the Java programming language. The indication component is integrated into the telephone dialling user interface. Each time the user enters a digit of the number, or erases one, the number currently being entered is sent to the indication component 6 by the getIndication( ) method. This component 6 responds with a character string which represents the corresponding indication. The terminal then displays this character string in a location reserved for this purpose on the screen.

The interface of the indication component is for example as follows:

```
“public interface TelephoneTariffIndicator {
/**
    * Gets the indication associated with a given ISDN
    * @param destinationISDN The destination ISDN for
which an indication is required
    * @return The tariff indication to be displayed
    */
    public  String  getIndication  (String
destinationISDN);
    /**
    * Time of expiration of the implementation in
seconds after Jan 1, 1970, 00:00:00 GMT
    */
    public long endOfLife( );
    }”
```

The implementation hereinbelow is an example of implementation of the indication component 6 complying with the interface hereinabove. It examines the prefix of the number and returns a character string indicating the connection tier. If it does not recognize the prefix, it declares itself inapt by returning “null.”.

```
“public  class  MyTelephoneTariffIndicator
implements TelephoneTariffIndicator {
  public  String  getIndication(String
  destinationISDN) {
    if (destinationISDN.startswith(“0800”))
        return “Freephone”;
    else if {destinationISDN.startsWith (“0890”))
        return “0.15 ε/min”;
    else if (destinationISDN.startswith (“0892”))
        return “0.337 ε/min”;
    else if (destinationISDN.startswith (“0899”))
        return “1.349 ε/call + 0.337 ε/min”;
    else
        return null;
    }
// End of life on Jan. 1, 2005
public long endOfLife( ) { return 1104595908; }
  }”
```

FIG. 2 represents at 2a the screen of a terminal 1 furnished with the component 6 specific to the operator A defined hereinbelow during the dialling of the telephone call number 0800123456, and at 2b the screen once dialling has terminated, when the component 6 has identified the type of number and the corresponding tariff rate (“freephone”).

In a second embodiment, a terminal according to the invention and similar to that represented in FIG. 1, comprises a component 7 specific to an operator B, which this time will bring about an event making it possible to ensure the user's agreement. Such a component is called the “agreement collection component”.

This is a variant, in which the component 7 is responsible for collecting the user's agreement so as to access the service. It is interrogated by the terminal when an application 5 wishes to access a service provided by an operator B. This component is responsible for ensuring the user's agreement in respect of the consumption of the service, then possibly for informing him thereafter of the consumption.

Thus, the invention allows competing operators, having different policies for informing the user, of offering their services to applications on the same terminal.

For example, a GPRS type service (mobile IP network), is offered by an operator A on the basis of a flat-rate tariff (a fixed amount per month), by two other operators B and C on the basis of a pay per use tariff (a certain amount per minute). The operator A will be able to offer this service to applications on the terminal with a trivial agreement collection component (that asks nothing from the user), since whatever consumption is made by the user, the latter will pay the same thing. The operator B will be able, on his side, to offer this service to applications on the terminal via an agreement collection component that will ask for agreement from the user beforehand, and that will maintain an indication on the screen for the duration of the connection. The operator C will be able to offer the service via an indication component that will display the corresponding tariff, before accessing the service.

FIG. 3 represents a terminal 1 comprising an agreement collection component 7 in the second embodiment of the invention.

To access the services of an operator B, an application 5 passes through an API 8 (Application Programming Interface) provided by the operating system 4. The API contacts the agreement collection component 7 via an interface of the agreement collection component, the implementation of the component having been provided by the service operator. As a function of the response from the agreement collection component 7 (agreement given or not given by the user), the API triggers the ordering of the service and allows the calling application to access same, according to a first architecture (FIG. 3a).

According to another architecture, it is the agreement collection component 7 itself that has the possibility of ordering the service requested by the application 6 and that gives the application the benefit thereof, should the user be in agreement.

The collection of agreement on the part of the component 7 may take varied forms. It may, for example, involve:
the response to a question posed to the user by means of the user interface 3 (for example: “Do you agree to this application accessing service X, billed at 0.10ε? Yes/No”), the user providing the response by way of the user interface 3;
the response to a similar question posed previously to the user and pertaining to several requests (for example: “Do you agree to this application accessing the service billed at 0.10ε48 Yes/Yes, always/No/No, never”);
the origin of the requesting application, determined by digital signing of the application (the application's signature certificate, or the certificate's certification string);
settings of the application 5 (for example in a page of settings of the application, the possibility of changing a setting: “Permit access to service X? Always, without asking me/Ask me each time/Never”), settings that can be adjusted by the user or by another “manager” (for example the IT department of a company in respect of services paid for by the company, or else the service operator itself B);
the settings of the operating system 4 (for example, default settings for all the applications signed by one and the same certificate), which settings can be adjusted by the user or by another “manager”.

This makes it necessary for the agreement collection component 7 to be able, depending on the case, to interact with the user (to pose questions and to receive the responses) and/or the operating system 4 (to ascertain the origin of the requesting application, the settings of the application or the settings of the system).

An exemplary implementation will be provided later in the description, furthermore deploying principles of aptness that are also introduced subsequently.

In a third embodiment, the principle that the operator provides the terminal with a code complying with an interface of the terminal is retained. In this case, this interface is that of the user interface components. The component is called the user interface component for access to the service.

A user interface component is a software component that an application 5 can place on the screen so as to interact with the user, for example by means of a graphical interface. Examples of user interface components are buttons, input fields, images, texts, etc. Libraries of user interface components exist in large number. A few examples are: AWT, SWING or LCDUI for Java technology; Mosaic or GTK on X11 systems.

In this embodiment, the application can access user interface components of a new type which for the application 5 are the only means of accessing the service.

The application 5 can place them on the screen, but has no influence on the way in which they interact with the user. The user can interact with this component in order to access the service (for example, in the case of a graphical interface, by clicking on the component), without interacting directly with the application 5. This allows the operator to be sure that the user is aware of the request that he makes, according to the criteria defined by the implementation of the user interface component for access to the service.

For example, in the case of a user interface consisting of a graphical display and of a mouse, the user interface component for accessing the service can have the form of a button that the application can place on the screen. The user can click on this button, thereby triggering access to the service. It is of course paramount that neither the application 5 nor any other element on the terminal can interfere in the interaction between the user and the user interface component for access to the service. This signifies that it must not be possible to modify the display of the user interface component for access to the service, and that the user's clicks cannot be simulated, either by the application 5, or by any other element on the terminal.

Several architectures for the user interface component for access to the service are achievable. A first architecture allows the operator to specify an entirely separate user interface component. Other architectures rely on the use of a user interface component present in advance on the terminal, the operator merely providing an indication component according to the first embodiment of the invention and/or an agreement collection component according to the second embodiment.

These architectures involving an indication component or an agreement collection component show an application of what is described hereinabove. This application can afford a service equivalent to that of the entirely separate user interface component.

In the first architecture, the component provided by the operator is the complete implementation of a user interface component or entirely separate user interface component.

Just as in the case of the user's agreement collection component, the user interface component can base its operation on the origin of the application, on the parameters of this application or on parameters of the system.

The user interface component for access to the service is directly accessible by the application 5. The latter can instance it, add it to the user interface, etc. The application 5 sends this component all the parameters for access to the service. It is the user interface component that thereafter accesses same in a standalone manner.

This user interface component is loaded by the service operator, as appropriate, to inform the user and to collect his agreement to order a service.

In another architecture, a user interface component for accessing the service is provided by the terminal. This component interfaces with an indication component provided by the operator. The user interface component integrates the management of the interaction with the user, whereas the indication component, provided by the operator, concentrates on what is specific to the operator in question.

In the example hereinbelow, an entirely separate user interface component is provided to the applications to allow them to send SMSs+.

The interface of the user interface component is for example also defined:

[import java.awt.*;
public interface IUEnvoiSMS {
/**
* Initializes the destination number, can only be
called once
* @param destination destination number of the
SMS
* @throws IllegalStateException if it is called
twice
* @throws IllegalArgumentException if the
destination number is keyed in wrongly
*/
public void initDestination (String destination)
throws IllegalStateException, IllegalArgumentException;
/**
* @return the IU component to be displayed
* @throws IllegalStateException if
initDestination has not been called before
*/
public Component getComponent( ) throws
IllegalArgumentException;
/**
* Specifies the message to be sent
* @param message the message to be sent
* @throws IllegalArgumentException the message is
too long or cannot be transported by SMS
*/
public void changeMessage (String message)
throws IllegalArgumentException;]

A possible implementation of the user interface component is to display a button whose text and colour differ depending on the tier of the SMS.

The above paragraphs describe various alternative embodiments of the invention, manifested in particular by various types of components.

Other aspects of the invention will now be described.

The code of a specific indication component, agreement collection component or else user interface component, can be delivered to the user's terminal by various means. For example, it may be written to the terminal before sale (“in the factory”), or else delivered by downloading. This downloading may be performed from a particular network or in a manner made secure by digital signing or else by a specific cable.

Upon the delivery by downloading of the indication component, the initiative of the delivery of the indication component may revert either to the terminal, or to the service operator, or to both.

Moreover, the link uniting a service operator and a suitable specific component may be just an authorization link and not necessarily a delivery link. Stated otherwise, a service operator might merely make the authorization of the implementation of a component known to the terminal, without necessarily intervening in its delivery.

For example, the following mechanism may be imagined: the terminal sends an operator a digest of the code of the operator specific component currently in the terminal, for example a digest obtained with the SHA-1 (“Secure Hash Algorithm”) hash algorithm. The operator responds by indicating whether this component is authorized by it to fulfil the indication function and/or agreement collection function and/or entirely separate user interface function for its own services.

The operator may possibly, supplementary to a negative response, grant access to the component, for example by sending an Internet URL accompanied by an SHA-1 digest. The terminal then connects up to the Internet to fetch the operator specific component from the indicated URL, and to verify its code with respect to the SHA-1 digest provided by the operator.

An indication component, or a component for collecting the user's agreement, can use various communication codes to inform the user of the type of tariff rate applicable for the service concerned. It may for example be the displaying of a price, of a tariff tier name, or else of colour codes relating to the tariff rate, an audible indication, vibrations, an olfactory code.

The component specific to the operator can also take into account several signals emanating from the user, for example the pressing of keyboard keys, contact with touch-sensitive surfaces, voice commands.

A component specific to the operator can interact with the operating system 4 of the terminal in various ways, like any software. For example, it can read parameters, in particular, in the case of mobile telecommunications, the roaming state of the terminal (since the tariffs may be different in the case of roaming). It can interact by writing parameters: for example, the component can use the memory of the terminal to remember the user's response to a certain question. It can have access to peripherals, or else enter into contact with the service operator.

An operator specific component can be more or less apt to inform the user, or collect his agreement, according to the service considered. This makes it possible to manage for example cases where the component is apt only in respect of part of the services in respect of a given operator.

Several components in respect of one and the same operator may then be bundled together, a component being selected as a function of its aptness to handle the service concerned, and of its priority (used in case of multiple aptness to determine which component should be selected).

A default component can also be specified.

The allocation of aptness is of course important for security. By way of example, aptness can be allocated directly by the terminal, as a function of the service considered and of the operator specific component. For example, in access to HTTP services, a component may be considered to be apt to collect the agreement of the user through the terminal having access to a URL u if and only if the component has been downloaded from a URL whose directory is a parent of u.

Aptness may also be allocated by an entity recognized by the terminal in respect of the services considered.

A component can also declare itself inapt in respect of a given service (independently of knowing whether the terminal considers it to be apt), this having no security implication.

In the example considered hereinbelow which illustrates both an implementation of a component of agreement collection type introduced earlier in the description, and an example of declaring aptness or otherwise, the service considered is the sending of SMSs+ (in France, SMSs with 6 digits billed in tiers indexed with regard to the first number). The applications can access this service by means of an API, the implementation of which subsequently calls upon the agreement collection component written in Java via its askPermission( ) method. The agreement collection component bases its decision on the signature of the requesting application, by trusting applications signed by a certain certificate. If this is insufficient, it asks for the explicit agreement of the user. It comprises the code allowing it to display on the screen a question to the user, by means of the LCDUI interface defined in MIDP Java 2.0.

The interface of the agreement collection component is as follows:

```
“import javax.microedition.lcdui.*;
public interface ManagerAgreementSMS {
    /**
    * Check the user's agreement before sending an
    SMS
    * @param destinationISDN destination number
    *  @param md5fingerprint Print MD5 of the
    application's signature root certificate, as
    appropriate
    * @param display user interface
    *  @return State of the agreement: OK = 1,
    Cancel = 0, inapt = −1
    */
    public  int  checkAgreement  (String
    destinationISDN,
        byte md5fingerprint[ ],
        Display display)
    throws InterruptedException;”
}
```

The implementation of the agreement collection component is for example:

```
  “import javax.microedition.lcdui.*;
  public class MyManagerAgreementSMS implements
ManagerAgreementSMS, CommandListener {
  static private final byte trustedMd5Fingerprint[ ] =
  {
  0x00, 0x01, 0x02, 0x03, 0x04, 0x05, 0x06, 0x07,
  0x08, 0x09, 0x0A, 0x0B, 0x0C, 0x0D, 0x0E, 0x0F,
  };
  Form question;
  StringItem itemNumber;
  Command Agreement;
  Command cancellation;
  int status;
  public MyManagerAgreementSMS ( ) {
    question = new Form (“Send SMS”);
    itemNumber = new StringItem{null,“”);
    question.append(“Pay service”);
    question.append(itemNumber);
    question.append(“Do you agree?”);
    Agreement = new Command (“OK”, command.OK, 1);
    cancellation = new Command (“Cancel”,
    Command.CANCEL, 2);
    question.addCommand (agreement);
    question.addCommand (cancellation)
    question. setCommandListener (this);
    status = −1;
}
public int checkAgreement(String destinationISDN,
        byte md5Fingerprint [ ],
        Display display)
      throws InterruptedException
{
  if (trustedMd5Fingerprint.equals(md5Fingerprint))
        return 1; //request originating from a
trusted application
  else if (display == null)
      return −1; //request in noninteractive mode:
inapt
  else if (destinationISDN.length( ) !=6)
      return −1; //the number is not an SMS+
  else {
      itemNumber.setText (“SMS+ tier” +
destination ISDN.charAt (O));
      status = −1;
      display.setCurrent (question);
      synchronized(this) {
        while (status ==−1)
            wait( );
        return status;
      }
  }
}
public void commandAction)Command c, Displayable d) {
  int newStatus;
  if (c == cancellation)
    newStatus = 0;
  else if (c == agreement)
    newStatus = 1;
  else
    newStatus = −1;
  synchronized(this) {
    status = newStatus;
    notify( );
  }
}
}
```

Thus, the user selects one of the services offered by an application, calling an API which triggers the sending of an SMS to the number “398765”, which is therefore an SMS+ at billing tier 3. An agreement collection component is invoked by the terminal. It recognizes that the number is an SMS+ and therefore tries to collect the user's response. The response may be of four types
1: the user is in agreement. The terminal must send the SMS.
0: the user is not in agreement. The terminal must not send the SMS.
−1: the agreement collection component is inapt. The terminal must use another agreement collection component (for example, a default component that presents the destination number of the SMS to the user).

InterruptedException: the application has been interrupted during the question to the user. The terminal must manage this exception.

FIG. 4 represents at 4a and at 4b an example corresponding to two successive states of a screen of a terminal, comprising an agreement collection component, corresponding to the component interface and to the implementation that were described above.

The screen represented at 4a offers the “Traffic Info” and “Weather” application to the user, who selects the “Weather Info” application. This application comprises the sending of an SMS. Before this sending, the execution of an associated agreement collection component causes the displaying of a request for agreement represented at 4b on the screen of the terminal.

The operator specific component can also be integrated into a log of service consumptions, when the terminal possesses one. Thus, for example, the services consumed in the past from the terminal can be summarized with tariff indications; the user can reorder a service ordered in the past, in which case the agreement collection component may intervene.

Thus the invention allows the varied wishes of operators as regards service security to be taken into account, while rationalizing the implementation in the terminal of applications making calls to services exhibiting particular access conditions and security specifications defined by each operator.

1. A of securing requests for access to services from a terminal able to communicate with a plurality of service operators delivering respective services, comprising the following steps:
furnishing the terminal with at least one software component provided by an operator delivering at least one service with a particular access condition,
upon a request for access to the said service from the terminal by way of a communications network, executing the software component provided by the operator locally in the terminal, the execution of the software component comprising at least the presentation to a user of the terminal of an indication defined by the operator in the component in relation to the particular access condition of the service.

2. The method according to claim 1, according to which a part at least of the particular access condition of the service is that the said service is a pay service and the indication provided to the user relates to the tariff of the service.

3. The method according to claim 1, according to which a part at least of the particular access condition of the service is that the said service comprises a processing of personal data, and the indication provided to the user relates to access by third parties to these personal data.

4. The method according to claim 1 according to which access to the service is not permitted by the terminal before the indication has been presented.

5. The method according to claim 1, according to which the indication comprises a request for agreement made locally to the terminal for the ordering of the service, and access to the service is rendered impossible by the terminal in the case where agreement is not obtained.

6. The method according to claim 5, according to which the request for agreement is asked of the user by way of a user interface with which the terminal is equipped, the response to the request for agreement being provided by the user.

7. The method according to claim 5, according to which the response to the request for agreement is provided by data stored in the terminal.

8. A terminal for securing requests for access to services, which is able to communicate with a plurality of service operators delivering respective services, comprising means including at least one security software component adapted to the implementation of the steps of a security method according to any one of the preceding claims.

9. The terminal according to claim 8, in which at least one security software component has been integrated into the terminal in the factory.

10. The terminal according to claim 8, in which at least one security software component has been loaded into or updated in the terminal by downloading.

11. The software module for securing requests for access to services, to be executed in a terminal able to communicate with a plurality of service operators delivering respective services, comprising instructions for implementing the steps of a method of securing requests for access to services according to claim 1.
